(19) United States
(12) Patent Application Publication
(10) Pub. No.: US 2007/0057581 A1
(43) Pub. Date: Mar. 15, 2007

(54) Rotating magnetic field and fixed conducting wire coil generator

(76) Inventor: Steven Miner, White Plains, NY (US)

Correspondence Address: FURGANG & ADWAR, 2 CROSFIELD AVENUE, WEST NYACK, NY, 10994, US

(21) Appl. No.: 11/505,671

(22) Filed: Aug. 17, 2006

Related U.S. Application Data
(63) Continuation-in-part of application No. 11/224,602, filed on Sep. 12, 2005, now abandoned.

(51) Int. Cl. H02K 9/00; H02K 1/12

(52) U.S. Cl. 310/52; 318/599; 310/254

(57) ABSTRACT

A system and method for generating power. A plurality of superconductive electromagnet pairs are disposed around a stationary coil in a circular pattern. The electromagnets of each respective electromagnet pair are positioned on opposing sides of the circular pattern. A control processor is connected to each electromagnet pair. When the control processor applies power to turn on and off the electromagnet pairs in a predetermined sequence, rotational and magnetic fields are generated and a current flow is induced in the stationary coil. The resulting current may be used to provide power to external systems and to operate the power generating system.

### BACKGROUND OF THE INVENTION

1. Field of the Invention

The present invention relates to power generators and more specifically to power generation systems.

2. Description of the Prior Art

Presently, large generators in power plants provide the power that flows across transmission lines and into homes and businesses. The generators operate through the use of magnetic fields. The most common generators use permanent magnets to produce the magnetic fields needed. The rotation of a conducting wire in a magnetic field causes an electric current to flow in the wire. A conducting wire wound into a coil generates a much larger quantity of voltage than a straightened wire when rotated in a magnetic field. The current produced by this voltage passes through conductors and/or wires to be used or stored.

Electricity may be generated by rotating the coil of wire in the magnetic field through any of numerous methods. The most popular methods for the generation of electricity by this means include the use of coal, oil and natural gas as well as water, wind, solar, and nuclear power methods. Combustion of the fossil fuels mentioned above are often objectionable due to the pollution they produce and alleged side effects associated therewith. Natural methods for generating energy such as those listed above only produce limited amounts of electricity while nuclear energy involves extremely dangerous nuclear reactors and nuclear waste. Therefore, there is a need for an efficient power generator which produces a minimal amount of pollution.

Increasing world-wide demand for oil to power vehicles is a central problem facing industrialized and emerging economies. Severely restricted access to oil could be the end to American life as we know it. According to Nicholas Varchaver in How to Kick the Oil Habit (Fortune, Aug. 23, 2004), “Some veteran observers think we are nearing the point—if we're not already there—at which the world's supply of crude (oil) peaks and then begins to decline. Even the optimists believe the start of the downward slope is only 35 years away. Frankly, it doesn't matter who's right. Three decades is precious little time to reconfigure the world energy system.”

Many variations of power generators exist in the prior art. One patent application (U.S. Pat. No. 5,857,762) describes rotating a ring of permanent magnets around the coil of wire instead of rotating the coil of wire within the ring of permanent magnets. This design provides an improved structure for the bicycle generator to which the invention is directed. Another patent (U.S. Pat. No. 5,430,009) discloses a stator disc and a rotor disc. The stator disc has wound coils cooled to induce the Meissner effect. The rotor disc is comprised of permanent magnets and hovers above the stator when cool. Subsequently, the rotor disc can be rotated virtually without friction. However, these variations do not disclose a power generator with a rotating electromagnetic field and stationary coil.

While these generators may be suitable for the purposes for which they were designed, they would not be as suitable for the purposes of the present invention, as hereinafter described.

### SUMMARY OF THE PRESENT INVENTION

It is an object of the present invention to provide a power generator having an improved structure able to minimize the loss of energy during the rotation process.

It is another object of this invention to provide a generator that has little or no magnetic field in the arc between a pair of superconducting electromagnets of the present invention.

Additionally, it is another object of the invention to provide a generator with little or no mechanical friction.

It is another object of the present invention to reduce the energy cost in a power generator.

It is another object of the invention to provide a power generator wherein a wire coil is located at the center of a plurality of superconducting electromagnets arranged in a circular pattern.

It is another object of the present invention to generate either direct current or alternating current.

It is another object of the present invention to provide a generator that substantially eliminates the use of fossil or nuclear fuels.

The foregoing and other objects and advantages will appear from the description to follow. In the description reference is made to the accompanying drawings, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawings, like reference characters designate the same or similar parts throughout the several views.

In one embodiment of the invention there is provided a system for generating power which comprises a stationary coil with a plurality of electromagnet pairs disposed around the stationary coil disposed in a circular pattern. The electromagnets of each respective electromagnet pair are positioned on opposing sides of the circular pattern. There is also provided a control processor connected to each electromagnet pair. The control processor applies power to turn on and off the electromagnet pairs in a predetermined sequence so as to generate rotational and magnetic fields and thereby inducing current flow in said stationary coil.

In yet another embodiment of the invention there is provided a method of converting energy which comprises providing a plurality of electromagnet pairs disposed around a stationary coil in a circular pattern, and wherein the electromagnets of each respective pair are positioned on opposing sides of the circular pattern; applying a voltage to activate the electromagnets of one of said plurality of electromagnet pairs; deactivating, after an expiration of a predetermined time period, the activated electromagnet pair; repeating the steps of activating and deactivating with the plurality of electromagnet pairs according to a predetermined sequence for inducing a current flow in the stationary coil; and providing the resulting current in the stationary coil to consumers.

The following detailed description is, therefore, not to be taken in a limiting sense, and the scope of the present invention is best defined by the appended claims.

### BRIEF DESCRIPTION OF THE DRAWING FIGURES

In order that the invention may be more fully understood, it will now be described, by way of example, with reference to the accompanying drawing in which:

FIG. 1 is an illustrative view of the power generator of the present invention in an AC mode of operation;

FIG. 2 is an illustrative view of the power generator of the present invention in a DC or an AC mode of operation;

FIG. 3 is an illustrative view of a superconducting electromagnet of the power generator of the present invention;

FIG. 4 is an illustrative view of the wire coil of the power generator of the present invention;

FIG. 5 is a power diagram of the power generator of the present invention;

FIG. 6 is a flow diagram of the power generator of the present invention in an AC mode of operation; and

FIG. 7 is a flow diagram of the power generator of the present invention in a DC mode of operation.

### DETAILED DESCRIPTION

The following discussion describes in detail embodiments of the invention. This discussion should not be construed, however, as limiting the invention to that particular embodiment. Practitioners skilled in the art will recognize numerous other embodiments as well. For definition of the complete scope of the invention, the reader is directed to appended claims.

The present invention relates to power generators and more specifically to a power generation system having a fixed coil of wire at the center of a plurality of electromagnets in a circular pattern. The electromagnets create a rotating magnetic field when activated to induce a current in the fixed coil. Additional power saving methods such as the use of superconducting electromagnetic coils to minimize the power needed to operate the power generator and rerouting current back into the system may be used to add to the effectiveness of the present invention.

The present invention in large form could be used to produce electricity for homes, businesses, and in a much smaller form could be part of an electric-powered vehicle and thus eliminating the need for “re-fueling.” Another version could produce electricity for factories and other large structures.

Magnetism is the power of repulsion or attraction that can be induced with an electric current in certain metals. Some metals, usually steel or steel alloys, retain these magnetic properties and are called permanent magnets. Other materials such as iron tend to lose its magnetic property almost immediately once power is removed, making these materials useful for electromagnets.

The structure comprises a coil of wire located at the center of a plurality of superconducting electromagnets arranged in a circular pattern. Each superconducting electromagnet is paired with another electromagnet directly across the circular pattern therefrom. In place of moving a magnetic field by physically moving permanent magnets, the superconducting electromagnets are activated and deactivated in a pattern which creates a rotating magnetic field. This eliminates friction from moving parts and thus further conserves energy within the system.

Any wire conducting electricity generates a circular field of magnetism around it. The greater the current flow in the wire, the greater the magnetic force generated around the wire. With a single wire, the magnetic force is usually of a very small amount, but the force can be multiplied many times by wrapping the wire in coils around a soft iron core. By simply turning the electricity on and off, the magnetic field is turned on and off. This is an electromagnet.

The way that generators currently work, a coil of wire is rotated within a stationary magnetic field provided by permanent magnets.

The concept behind the present invention is that instead of rotating a coil of wire through a stationary magnetic field produced by permanent magnets, the magnetic field itself is rotated via selectively turning a plurality of electromagnets on and off in a circular pattern with the coil of wire remaining in a stationary position. If the speed of the device necessitates, there could be a magnetic field that increases and falls back to a predetermined level as a wave of magnetism.

The present invention may use superconducting electromagnetic coils to induce the magnetic field. A superconductor is a material that reduces the resistance to the flow of electrical current once it has been cooled to a certain temperature. In a conductor such as copper, an electric current is produced when electrons flow through the material. The structure of the superconducting material is in the form of a crystal lattice. Electrons scatter around because they encounter imperfections in the lattice structure. This movement of the electrons creates heat, which vibrates the lattice structure. This vibration hinders the movement of the electrons. At super-cold temperatures, these effects disappear and all resistance to current flow vanishes. Superconductivity is achieved by cooling the material with liquid helium at temperature approaching absolute zero (0° Kelvin, or −459.69° F.). Liquid helium may be used to cool the electromagnetic coils and make them superconductive.

Using superconducting electromagnets to create the magnetic fields provides a significant reduction in the amount of energy (electricity) lost as opposed to other methods of producing magnetic fields. After a pulse of electricity passes through a superconducting electromagnetic coil and then into the wire coil, that electricity is channeled back from the wire coil for use in the system.

Each paired pulse of electricity creates a magnetic field, with a north and a south pole and with a force dependant on the amount of current (electron flow). The force of the magnetic field is exerted on the coil of wire within the field. During the sequence of paired pulses, the magnetic field rotates, generating a current of electricity in the coil of wire at the center. The current flows to a distribution system capable of distributing power to homes and businesses. Alternatively, the electricity can be provided locally such as in the case of an automobile, a large structure such as a factory, an apartment building or a hospital, or using a portable generator. Thus, rotational energy is transferred to the wire coil at the same time that magnetic force is being applied to the coil. This dual force is a crucial idea of the present invention. When the coil of wire in a standard generator is stationary in the magnetic field no current flows in the wire. Electricity (electron flow) is generated in the wire within the first increment of coil rotation. This means that, since electricity is a form of energy, and since there is no electricity when the coil of wire is stationary (in a standard generator); and since to produce energy there must be a corresponding input of another form of energy; therefore rotational energy is input when the coil of wire rotates in a standard generator. Similarly, rotational energy is input into the system when a magnetic field rotates around a stationary coil.

It is possible that a material other than iron may need to be used for the electromagnets if iron does not lose its magnetic property quickly enough after the power is removed from the device to work effectively, or that a new material may have to be created to make the device work effectively.

Alternatively, the system of the present invention may include ceramic electromagnetic coils instead of copper. Some ceramics are superconductive at 90° K. or above. The ceramic coils are cooled with liquid nitrogen more routinely as liquid nitrogen is more common than liquid hydrogen. Additionally, liquid nitrogen is easier to keep liquid than liquid hydrogen and is almost as safe as liquid helium. Alloys of certain metals are superconductive at liquid hydrogen temperatures; however, liquid hydrogen can burn and can produce vapors of hydrogen gas that can explode.

The present invention uses superconductive electromagnets to reduce the resistance in the flow of electrical current in the electromagnetic coils. When cooled to a certain temperature the vibration of the lattice structure, which hinders the movement of electrons, is reduced.

The present invention uses alternating current and/or direct current electromagnets whose structures are well known in the art. Each electromagnet, as generally and schematically described below, is connected within its circuitry to its respective source of current also in a manner well known in the art (and not fully shown).

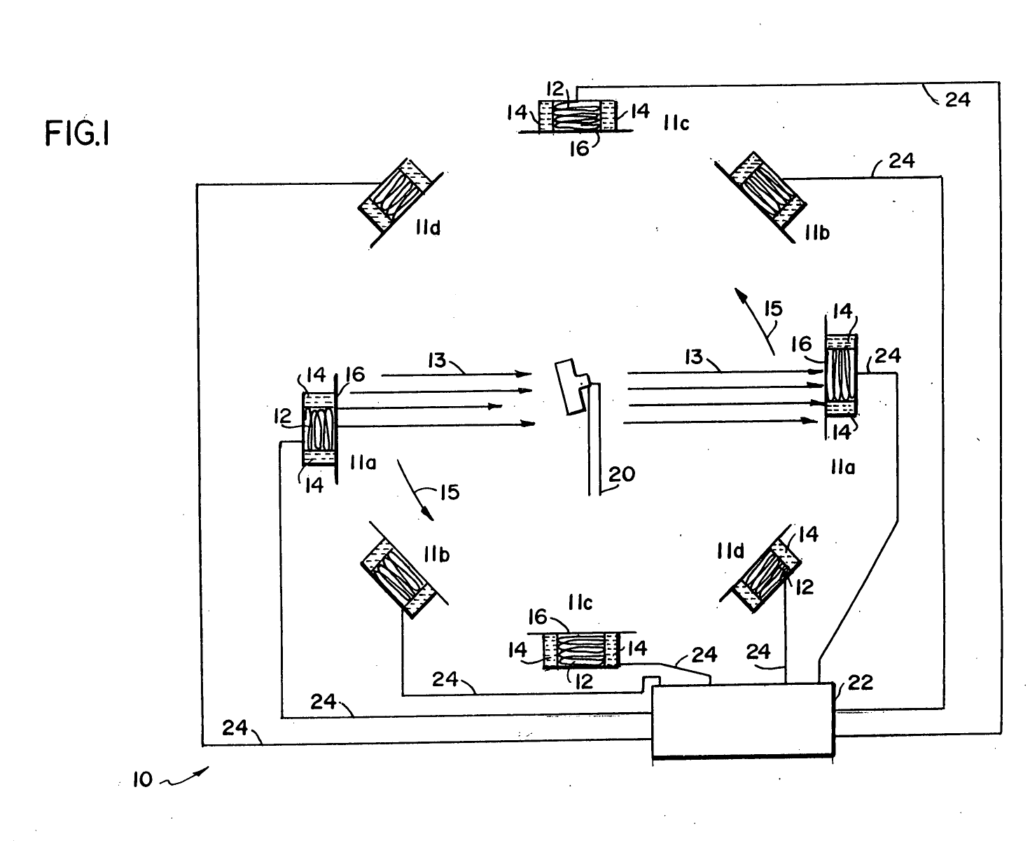

Turning now to the drawing, in which similar reference characters denote similar element throughout the several views, FIGS. 1-7 illustrate the power generator of the present invention. FIG. 1 illustrates the generator configured for generating an alternating current. The power generator consists of a wire coil 20, a plurality of alternating current electromagnet pairs 11a-11d and a control processor 22. The electromagnets are arranged in a substantially circular pattern. A first electromagnet of each pair is positioned directly opposite the circular pattern from a second electromagnet of the respective pair. The wire coil 20 is positioned at substantially the center of the circular pattern. Four pairs of electromagnets are provided in the illustrated embodiment for purposes of example only. In practice any desired number of electromagnet pairs may be used.

The alternating current magnets are superconducting electromagnets. Each respective superconducting electromagnet includes a superconductive electromagnetic coil 12, cooling elements 14 and an emitter plate 16. When current is passed through the superconductive electromagnetic coil 12 a proportionate amount of magnetic force is emitted around the coil 12. The structure of the material in the coil 12 is in the form of a crystal lattice. As is well known, at room temperatures some of the electrons passing through the lattice structure are caused to scatter because they encounter imperfections in the lattice structure. This movement of electrons causes heat, which in turn causes the lattice structure to vibrate. This vibration hinders the movement of electrons. At super-cooled temperatures (nearing absolute zero) these effects virtually disappear and improved current flow through the material is easily achieved. The superconductive electromagnetic coil 12 is surrounded by cooling elements 14. The cooling elements 14 use liquid helium to cool the superconductive electromagnetic coil 12. However, other cooling agents such as liquid hydrogen and liquid nitrogen may be used to cool the electromagnetic coil 12. The magnetic force emitted from the superconductive electromagnetic coil 12 is channeled through the emitter plate 16.

Each pair of superconductive alternating current electromagnets 11a-11d is connected to and controlled by processor 22 via control wires 24. The processor 22 simultaneously signals a pair of the electromagnet pairs 11a-11d to be activated. The first electromagnet of each pair has a first polarity and the second electromagnet of each respective pair has a second polarity opposite the polarity of the first electromagnet. These opposite polarities create a magnetic field 13 between the pair of active superconducting electromagnets 11. For example, processor 22 simultaneously causes the first electromagnet 11a to have a north polarity and the second electromagnet 11a to have a south polarity creating a magnetic field 13 between the pair of superconducting electromagnets 11a.

Processor 22 controls the power output generated by the system as well as the timing pattern for activating each of the superconducting alternating current electromagnetic coil pairs 11a-11d to create a fluid motion rotating magnetic field. Thus, the processor 22 may control the pulse patterns or pulse strength to create a rotating peak of the magnetic field. Accordingly, the processor 22 may control the strength of the pulses emitted from the superconducting electromagnetic pairs 11a-11d. These factors allow the processor 22 to have full control over the system parameters.

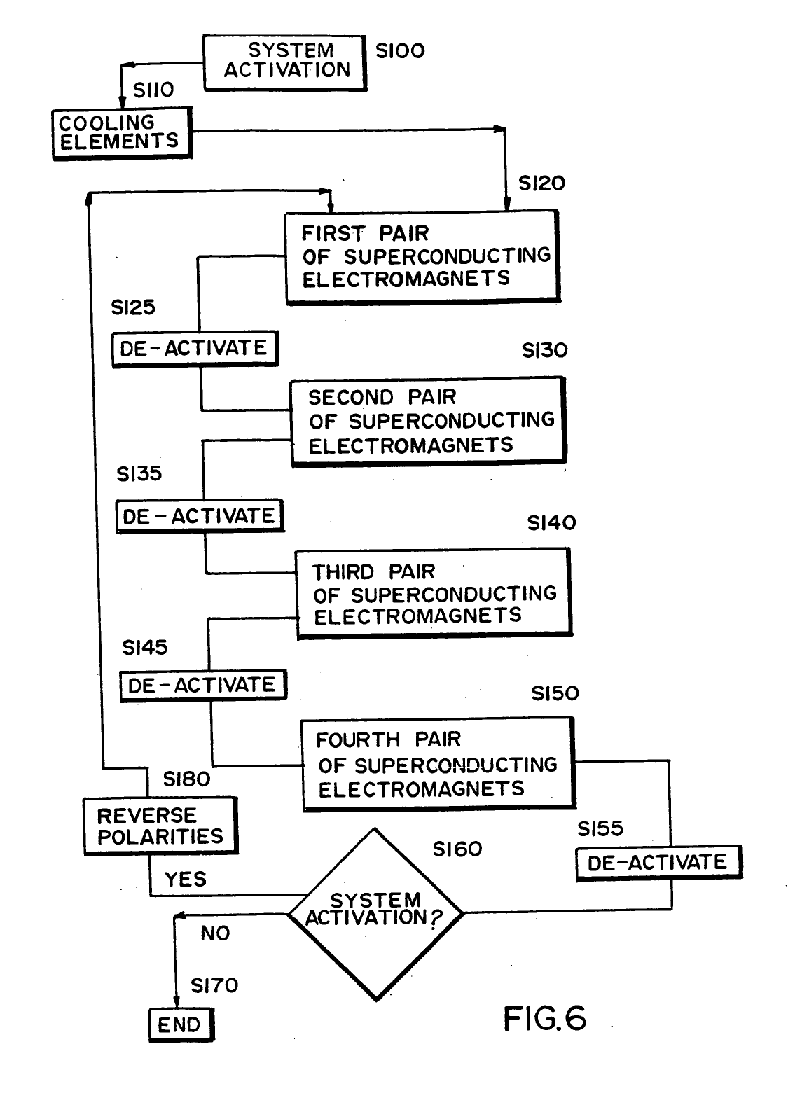

The superconducting alternating current electromagnet pairs 11a-11d are powered in a rotational order indicated by rotational arrows 15. As a new pair of superconducting electromagnets 11a-11d are powered, the previous pair of active superconducting electromagnets is deactivated so only a single pair of electromagnets is active at any one time. For example, as electromagnet pair 11b is activated electromagnetic pair 11a is deactivated and consequently as electromagnet pair 11c is activated electrom agnetic pair 11b is deactivated. In alternate embodiments, the timing of rotation and number of active elements may change. In another example, electromagnet pair 11a may remain active for some time after electromagnet pair 11b is activated, with electromagnet pair 11a then being deactivated while electromagnet pair 11b remains activated and so on. With each successive activation of a respective pair the polarities of the superconducting electromagnets of the pair are switched. Thus, the magnetic field 13 rotates beginning between pair 11a, then pair 11b, then pair 11c, then pair 11d and then repeated with the polarities reversed. This switching of polarities creates the second half of rotation of the magnetic field. The switching of polarities according to the activation pattern causes the device to generate an alternating current. This rotating magnetic field 13 creates a large voltage in the wire coil 20 stationed at the center of the ring of superconductive electromagnets 11. This process will be discussed in greater detail with specific reference to FIG. 6.

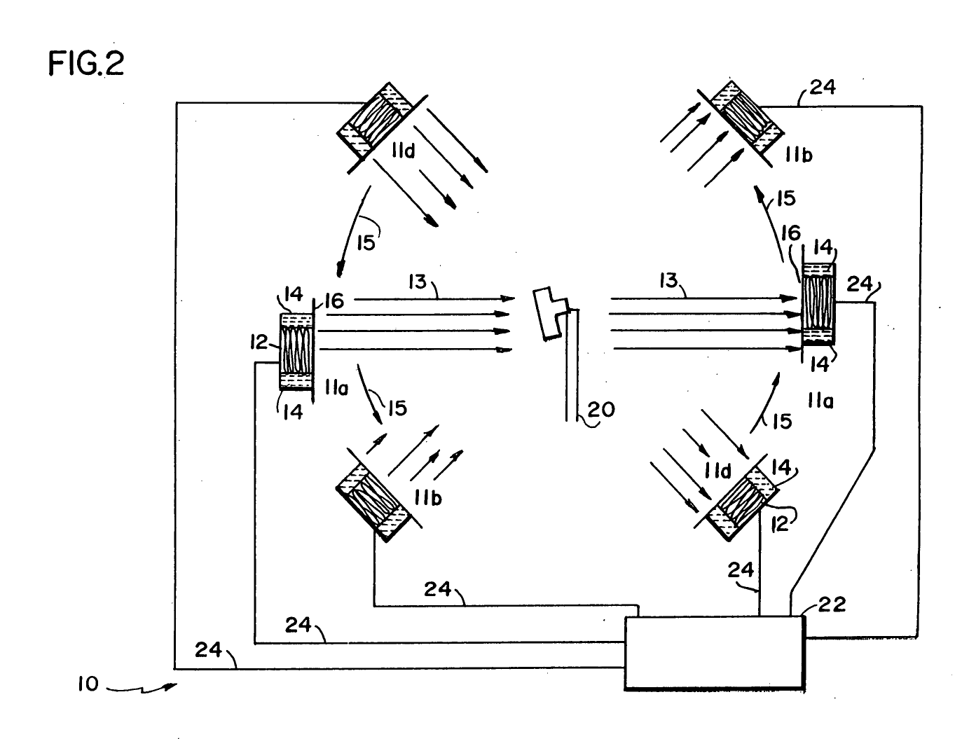

In an alternate embodiment, alternating current may be provided by exciting a magnetic field in selective coils where the rotation of the magnetic field alternates direction. Thus, referring to FIG. 2, the magnetic field is placed on one set of coils and then removed and placed on another set of coils in this order: 11a, 11b, 11a, 11d, 11a, 11b, 11a, 11d, and so on. In another alternate embodiment, the timing of rotation and number of active elements may change. For example, electromagnet pair 11a may remain active for some time after electromagnet pair 11b is activated, with electromagnet pair 11a then being deactivated while electromagnet pair 11b remains activated and so on. This embodiment uses direct current electromagnets—the superconducting electromagnets of each pair maintain their polarities as opposed to FIG. 1 in which the polarities of a pair switch with each activation of the pair.

There are different rotational patterns and electromagnet configurations depending on whether the device is used to generate direct current or alternating current. FIG. 2 illustrates the generator configured for generating a direct current using direct current electromagnets. Similar reference numerals are used to denote elements in common with FIG. 1. A direct current flows in a single direction. Therefore, as opposed to FIG. 1 in which the polarities of the superconducting electromagnets of a pair switch with each activation of the pair, the superconducting electromagnets of each pair maintain their polarity.

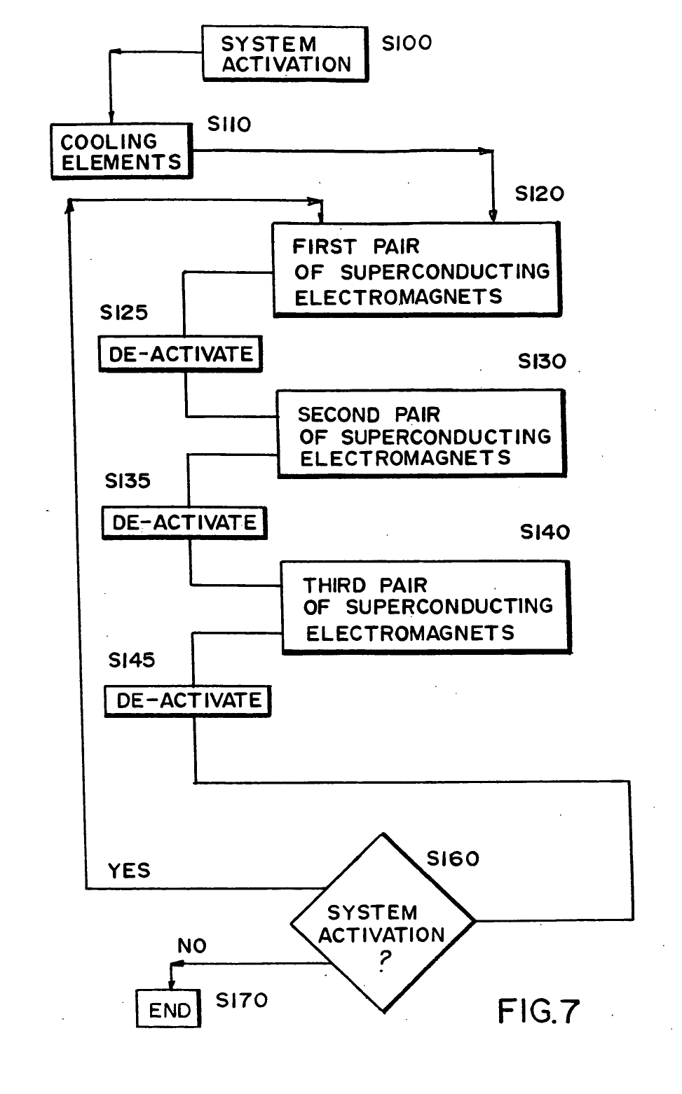

The superconducting direct current electromagnet pairs 11a, 11b, 11d are powered in a rotational order indicated by rotational arrows 15. As a new pair of superconducting electromagnets 11a, 11b, 11d are powered, the previous pair of active superconductive electromagnets is deactivated so only a single pair of electromagnets is active at any one time. In another alternate embodiment, the timing of rotation and number of active elements may change. For example, electromagnet pair 11a may remain active for some time after electromagnet pair 11b is activated, with electromagnet pair 11a then being deactivated while electromagnet pair 11b remains activated and so on. The magnetic field 13 rotates beginning between pair 11a, then pair 11b, then pair 11d and repeated. This rotating magnetic field 13 creates a large voltage in the wire coil 20 stationed at the center of the ring of superconductive electromagnets 11. This process will be discussed in greater detail with specific reference to FIG. 7.

In the way that standard generators work to produce direct current, when the moving coil is crossing the lines of force of the magnetic field, the maximum amount of voltage is provided in the coil. This amount decreases as the coil rotates. When the coil is parallel to the lines of force of the magnetic field, it is crossing the lines of force, and no current is produced. In the present invention, when producing direct current, or when producing alternating current without changing polarities of the electromagnets, the stationary coil is never parallel or relatively parallel to the lines of force of the magnetic field, since there are no electromagnets at the position occupied by electromagnet pair 11c denoted in FIG. 1(see FIG. 2). In this way, the present invention is more efficient then standard generators.

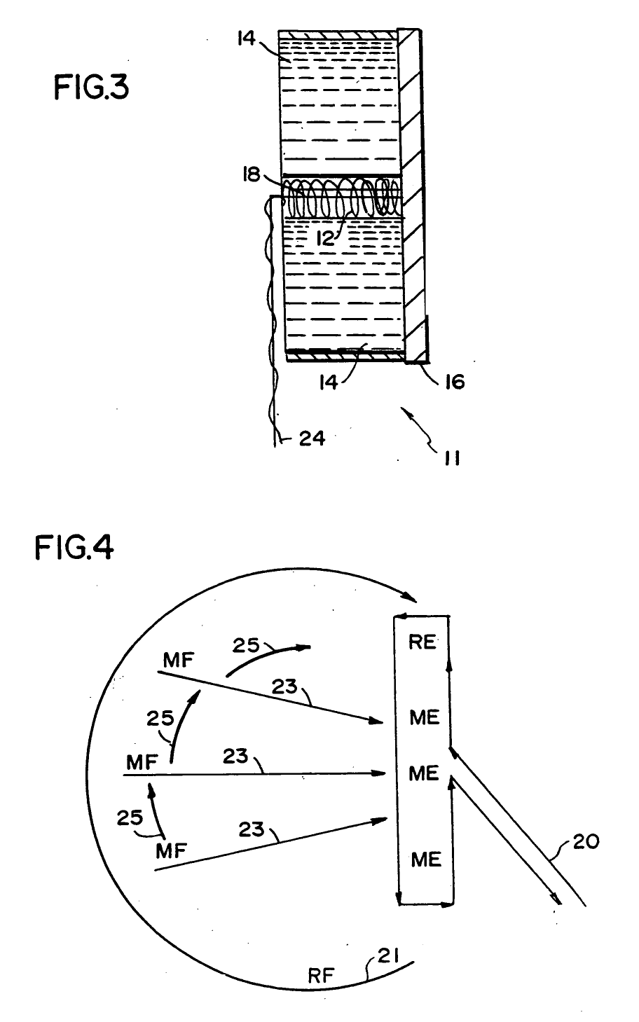

FIG. 3 is an illustrative view of the embodiment of a superconducting electromagnet 11 of the present invention (FIG. 3 discloses either an alternating current or direct current electromagnet). The superconducting electromagnet 11 consists of a superconducting electromagnetic coil 12, an iron core 18, cooling elements 14 and an emitter plate 16. A control wire 24 extends from control processor 22 (FIG. 1) to the superconducting electromagnetic coil 12. This connection applies a voltage to the superconducting electromagnetic coil 12 and thereby controls the operation of the superconducting electromagnet 11. The superconducting electromagnetic coil 12 is wrapped around a soft iron core 18. Iron is the standard used in electromagnets and is described herein. However, any other metal or alloy which gains and loses magnetic charge quickly may be used. The iron core 18 and surrounding coil 12 is designed as a simple coil and attached perpendicular to an emitter plate 16. This configuration is provided for purposes of example only. It should be understood that other designs and configurations may be used with the system of the present invention. Emitter plate 16 directs the magnetic field produced by superconducting electromagnetic coil 12 towards the wire coil 20 when the superconducting electromagnet 11 is activated. The structure of the material in the coil 12 is in the form of a crystal lattice. Some of the electrons flowing through the crystal lattice scatter because they encounter imperfections in the lattice structure. This movement of electrons causes heat, which in turn causes the lattice structure to vibrate. This vibration hinders the movement of electrons. At super-cooled temperatures (nearing absolute zero) these effects virtually disappear and current flow through the material is easily achieved. Therefore, cooling elements 14 surround superconducting electromagnetic coil 12 to cool the superconducting material to a temperature which better facilitates current flow. In one embodiment, cooling elements 14 are composed of liquid helium. In alternate embodiments, superconducting ceramic electromagnetic coils or superconducting metal alloy electromagnetic coils may be used in place of the superconducting copper electromagnetic coils 12 and liquid nitrogen or liquid hydrogen may be used in place of liquid helium to cool the superconducting electromagnetic coil 12.

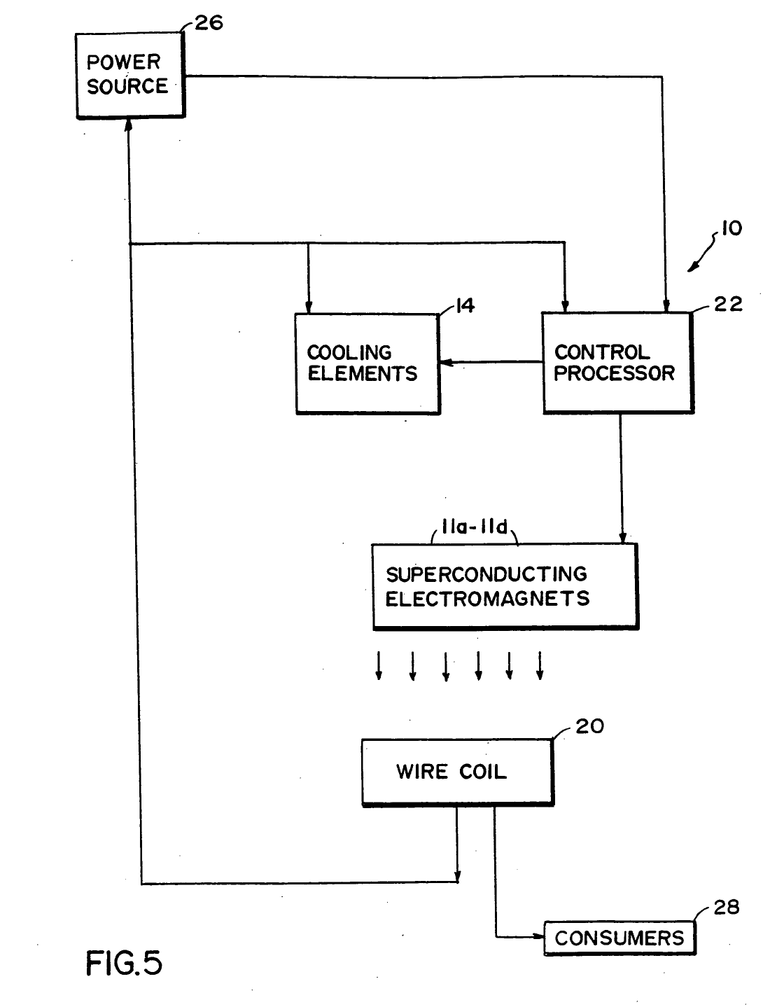

FIG. 4 is an illustrative view of the flow of current within the wire coil 20 of the power generator 10 of the present invention. In standard generators, a coil of wire rotates within a magnetic field transforming rotational energy and magnetic energy into electrical energy. When stationary, the wire 20 in the magnetic field is void of any rotational energy 21 and subsequently lacks current. Any minute increment of coil rotation generates an electron flow (current) within the coil. The present invention replaces the rotational energy 21 input (for example, where the coil is rotated by use of fossil fuel) as required in prior art systems to turn the coil 20 with a sequentially rotating magnetic field 25, 23 as shown herein. The rotating sequence of paired pulses described herein above in FIG. 1 creates a current within coil 20. Therefore, rotational energy is transferred to the wire coil 20 at the same time magnetic force 23 is applied to the coil 20. This rotational energy is directly related to the physical rotation of the wire coil 20.

For ease of understanding, FIG. 4 illustrates the rotational energy 25 separate from the magnetic force 23. However, in reality rotational force and magnetic force act simultaneously on the system in a synergistic manner and impart a combination of rotational and magnetic energy to the wire coil 20. This energy causes the electrons within the wire coil 20 to flow creating a current. This current delivers electricity out of the system. The current/electricity flowing out of the system is used for providing power to consumers when the current is transferred along power lines or for providing power for vehicles or large structures as well as for powering the power generator system 10 when directed back into the system. The current/energy directed back into the system is directed towards the cooling elements 14 as well as the control processor 22.

FIG. 5 is a power diagram of the power generator of the present invention. The power generator 10 of the present invention includes a power source 26. Power source 26 provides power to control processor 22. When the control processor 22 starts the power generation process, as will be described further in reference to FIG. 6, power is supplied from the control processor 22 to cooling elements 14 and superconducting electromagnets 11. The cooling elements 14 cause the temperature of the superconducting electromagnets 11 to decrease when activated. The lower operating temperature allows the superconducting electromagnets 11 to function with a minimal loss of energy. The pairs of superconducting electromagnets (11a-11d for generating alternating current and 11a, b, d for generating direct or alternating current) are activated in a rotating order to induce a current within the stationary wire coil 20. The resulting electricity from the wire coil 20 is supplied to consumers 28 as well as back to cooling elements 14, control processor 22 and power source 26. The electricity supplied to the cooling elements 14 and the control processor 22 allows the power generator 10 to continue to function with a minimal amount of input electricity. The electricity supplied to power source 26 recharges the power source for future use as well as to alleviate the drain of power from the power generator 10.

FIG. 6 is a flow diagram illustrating the operation of the power generator of the present invention in an alternating current generation mode. The system is activated in step S100. Once activated, the system activates the cooling elements alongside the superconducting electromagnets, as described in step S110. The cooling of the superconducting electromagnets cools the superconducting material to a temperature which better facilitates current flow. The pairs of superconducting electromagnets are then activated and deactivated in a rotational pattern around the circular arrangement thereby creating a rotating magnetic field. A first pair of superconducting electromagnets in the substantially circular arrangement is then activated in step S120 creating a magnetic field through a stationary wire coil located substantially in the center of the ring of superconducting electromagnets. The first pair of superconducting electromagnetic elements is then deactivated and a second pair of superconducting electromagnets adjacent to the first pair is activated, as illustrated by step S130. The second pair of superconducting electromagnetic elements is then deactivated and a third pair of superconducting electromagnets adjacent to the second pair is activated, as illustrated by step S140. The third pair of superconducting electromagnetic elements is then deactivated and a fourth pair of superconducting electromagnets adjacent to the third pair is activated, as illustrated by step S150. The process continues to activate a subsequent adjacent pair of superconducting electromagnets and deactivate the activated pair through a full rotation around the circular pattern. In another alternate embodiment, the timing of rotation and number of active elements may change. In this example, the first pair of electromagnets may remain active for some time after the second pair of electromagnets is activated, with the first pair of electromagnets then being deactivated while the second pair of electromagnets remains activated, and so on. The system continuously checks if it is still activated, as displayed in step S160. If the system is active then the system proceeds to switch the polarities of the superconducting electromagnets within each pair in step S180. Once switched, the system proceeds back to step S120. If the system has been deactivated then the system proceeds to the end and terminates the process, as displayed in step S170.

FIG. 7 is a flow diagram illustrating the operation of the power generator of the present invention in a direct current generation mode. Similar reference numerals are used to denote elements in common with FIG. 6. The system is activated in step S100. Once activated, the system activates the cooling elements alongside the superconducting electromagnets, as described in step S110. The cooling of the superconducting electromagnets cools the superconducting material to a temperature which better facilitates current flow. The pairs of superconducting electromagnets are then activated and deactivated in a rotational pattern around the circular arrangement thereby creating a rotating magnetic field. A first pair of superconducting electromagnets in the substantially circular arrangement is then activated in step S120 creating a magnetic field through a stationary wire coil located substantially in the center of the ring of superconducting electromagnets. The first pair of superconducting electromagnetic elements is then deactivated and a second pair of superconducting electromagnets adjacent to the first pair is activated, as illustrated by step S130. The second pair of superconducting electromagnetic elements is then deactivated and a third pair of superconducting electromagnets adjacent to the second pair is activated, as illustrated by step S140. The third pair of superconducting electromagnetic elements is then deactivated. The process continues to activate a subsequent adjacent pair of superconducting electromagnets and deactivate the activated pair through a full rotation around the circular pattern. In another alternate embodiment, the timing of rotation and number of active elements may change. In this example, the first pair of electromagnets may remain active for some time after the second pair of electromagnets is activated, with the first pair of electromagnets then being deactivated while the second pair of electromagnets remains activated, and so on. The system continuously checks if it is still activated, as displayed in step S160. If the system is active then it proceeds to activate the first pair of superconducting electromagnets in a second rotation of the circular pattern in step S120. If the system has been deactivated then the system proceeds to the end and terminates the process, as displayed in step S170.

Many factors may be varied to maximize the output of electricity for the power generator. The strength and length of the pulses output by the superconducting electromagnets affect the current in the wire coil and therefore may be varied for optimal settings. The size and configuration of the windings, type of superconducting material, and size and shape of the superconducting electromagnets may also be varied as well to affect the resulting magnetic field. The varying of the materials used in the cooling elements affect the rate and efficiency of the cooling process and may therefore be varied for optimal output. The number and configuration of the superconducting electromagnets as well as the location of the coil wire can be varied as to acquire the optimal positioning for a specific embodiment. Each of these factors and elements may be used to optimize the operation of the present invention. Selection of the strength and length of the pulses as well as the materials used to produce the present invention are design choices made by the user.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. A system for generating power comprising:
a) a stationary coil;
b) a plurality of electromagnet pairs disposed around said stationary coil in a circular pattern, wherein electromagnets of each respective electromagnet pair are positioned on opposing sides of said circular pattern; and
c) a control processor connected to each electromagnet pair, wherein said control processor applies power to turn on and off said electromagnet pairs in a predetermined sequence generating rotational and magnetic fields and thereby inducing current flow in said stationary coil.

44. The system of claim 43, wherein said stationary coil is a multi-turn coil.

45. The system of claim 43, wherein said electromagnets of said plurality of electromagnet pairs are superconducting electromagnets.

46. The system of claim 45, wherein each electromagnet of said plurality of electromagnet pairs further includes a cooling element for cooling said superconducting electromagnet.

47. The system of claim 43, wherein each electromagnet comprises:
a) a core able to retain and lose magnetic charge;
b) an electromagnetic coil wrapped around said core; and
c) an emitter connected to each of said core and said electromagnetic coil for emitting a magnetic force therefrom.

48. The system of claim 47, wherein said core is a soft iron core.

49. The system of claim 47, wherein said electromagnetic coil is superconducting.

50. The system of claim 49, wherein each of said superconducting coils are cooled by a respective cooling element to a temperature approaching absolute zero.

51. The system of claim 43, wherein said electromagnets of each respective pair have opposing polarities.

52. The system of claim 43, wherein said predetermined sequence is a circular pattern in an AC mode of operation.

53. The system of claim 52, wherein said pairs of superconducting electromagnets reverse polarities within said circular pattern.

54. The system of claim 43, wherein said predetermined sequence is a circular pattern in a DC mode of operation.

55. The system of claim 54, wherein said pairs of superconducting electromagnets have static polarities within said circular pattern.

56. The system of claim 43, wherein said predetermined sequence is a semi-circular pattern which functions in a forward and subsequent reverse direction in an AC mode of operation.

57. The system of claim 56, wherein said pairs of superconducting electromagnets have static polarities within said semi-circular pattern.

58. The system of claim 46, wherein said cooling element includes one of liquid helium, liquid hydrogen or liquid nitrogen.

59. The system of claim 58, wherein said cooling element is operable to release said one of liquid helium, liquid hydrogen or liquid nitrogen at a predetermined rate thereby controlling the temperature of a respective superconducting coil.

60. The system of claim 43, wherein at least a part of said induced current is fed back to said control box and said cooling elements.

61. The system of claim 46, wherein said control processor controls at least one of:
a) activation timings of said superconducting electromagnet pairs;
b) deactivation timings of said superconducting electromagnet pairs;
c) strength of the magnetic field emitted by said superconducting electromagnet pairs;
d) activation of said cooling elements; and
e) deactivation of said cooling elements.

62. A method of converting energy comprising the activities of:
a) providing a plurality of electromagnet pairs disposed around a stationary coil in a circular pattern, positioning the electromagnets of each respective pair on opposing sides of the circular pattern;
b) applying a voltage to activate the electromagnets of one of the plurality of electromagnet pairs;
c) deactivating, after an expiration of a predetermined time period, the activated electromagnet pair;
d) repeating activities of b) and c) with the plurality of electromagnet pairs according to a predetermined sequence for inducing a current flow in the stationary coil; and
e) providing the resulting current in the stationary coil.

63. The method of claim 62, wherein the step of providing a stationary coil includes providing a multi-turn coil.

64. The method of claim 62, wherein the step of providing electromagnets of the plurality of electromagnet pairs includes providing superconducting electromagnets.

65. The method of claim 62, wherein the step of providing each electromagnet comprises providing:
a) a core, retaining and losing magnetic charge in the core;
b) an electromagnetic coil, wrapping the electromagnetic coil around the core; and
c) an emitter, connecting the emitter to each core and the electromagnetic coil, causing, by the emitter, the emitting of a magnetic force therefrom.

66. The method of claim 65, wherein the step of providing the core includes providing a soft iron core.

67. The method of claim 65, wherein the step of providing the electromagnetic coil includes that the coil is superconducting.

68. The method of claim 62, wherein the step of providing electromagnets includes providing at least one cooling element, cooling by use of the cooling element, the respective electromagnet.

69. The method of claim 68, the step of providing at least one cooling element including providing a cooling element for each electromagnet, and the step of inducing current in the stationary coil includes providing at least a part of the current to the cooling elements.

70. The method of claim 69, further includes activating the cooling elements and cooling thereby the electromagnets of the activated pair.

71. The method of claim 70, wherein the step of activating the cooling elements further comprises cooling the electromagnets to a temperature approaching absolute zero.

72. The method of claim 70, wherein the step of applying includes at least one of:
a) controlling activation timings of the electromagnet pairs;
b) controlling deactivation timings of the electromagnet pairs;
c) determining the strength of the magnetic field emitted by the electromagnet pairs;
d) activating the cooling elements; and
e) deactivating the cooling elements.

73. The method of claim 71, wherein the step of providing cooling elements includes providing at least one of liquid helium, liquid hydrogen, or liquid nitrogen.

74. The method of claim 73, wherein the step of activating the cooling elements includes releasing one of liquid helium, liquid hydrogen, or liquid nitrogen at a determined rate for controlling the resulting temperature.

75. The method of claim 62, further comprises providing the electromagnets of each respective pair with opposing polarities.

76. The method of claim 75, wherein the step of providing a predetermined sequence includes providing the sequence in a rotational pattern in an AC mode of operation.

77. The method of claim 75, wherein the step of providing the electromagnets with opposing polarities includes reversing the polarities of the pairs of superconducting electromagnets within the circular pattern.

78. The method of claim 75, wherein the step of providing a predetermined sequence includes providing the sequence in a rotational pattern in a DC mode of operation.

79. The method of claim 78, wherein the step of providing the pairs of superconducting electromagnets includes providing the electromagnets with static polarities within the circular pattern.

80. The method of claim 75, wherein the step of providing a predetermined sequence includes providing the sequence in a semi-circular pattern so as to function in a forward and subsequent reverse direction in an AC mode of operation.

81. The method of claim 80, wherein the step of providing pairs of superconducting electromagnets includes providing the superconducting electromagnets with static polarities within the semi-circular pattern.

82. The method of claim 62, wherein the step of deactivating an active electromagnet pair and activating a next electromagnet pair occur simultaneously.

83. The method of claim 62, wherein the step of activating and deactivating further comprises providing a control processor; and controlling, with the control processor, the steps of applying and deactivating.

84. The method of claim 83, wherein the step of providing the resulting current in the stationary coil includes diverting at least a part of the current to the control processor.

85. The method of claim 62 wherein steps b) and c) include deactivating one pair of electromagnets at or before activating the next pair of electromagnets.

86. The method of claim 62 wherein steps b) and c) include deactivating one pair of electromagnets after activating the next pair of electromagnets so that the magnetic fields of the pairs of electromagnets overlap.
